(19) United States
(12) Patent Application Publication
(10) Pub. No.: US 2006/0256263 A1
(43) Pub. Date: Nov. 16, 2006

(54) Liquid crystal display device having form birefringent compensator

(75) Inventors: Jeffrey Arthur Shimizu, Cortlandt Manor, NY (US); Duncan J. Anderson, Hollow, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/557,349

(22) PCT Filed: May 14, 2004
(86) PCT No.: PCT/IB04/01669

§ 371 Date: Nov. 21, 2005

(30) Foreign Application Priority Data
May 22, 2003 (US) 60472604

(51) Int. Cl. G02F 1/1335

(52) U.S. Cl. 349/113

(57) ABSTRACT

A liquid crystal display device (500) includes first and second substrates (510, 530); a liquid crystal layer (522) disposed between the first and second substrates (510, 530); a pair of electrodes (520, 526) for selectively changing an orientation of liquid crystal molecules of the liquid crystal layer (522) to selectively control a polarization of light passing through the liquid crystal layer (522); and a form birefringent compensator (550) on a surface of one of the two substrates (510, 530) through which the light passes. The form birefringent compensator (550) may comprise a series of gratings having a rectangular or triangular cross-section. The form birefringent compensator (550) compensates for a residual retardance produced by the liquid crystal layer (522) when the device (500) is operating in a dark state.

This invention pertains to the field of display devices, and more particularly, to liquid crystal display devices having birefringent compensators.

Liquid crystal display (LCD) devices continue to grow in popularity and in sales. LCDs are increasingly being used not only as display devices for computers, but also in televisions and video monitors. A liquid crystal on silicon (LCOS) device is a type of liquid crystal device that is increasingly being used in projection display systems, such as projection televisions and projection video monitors. More specifically, a projection display system utilizing a reflective LCOS panel is described in U.S. Pat. No. 5,532,763 to Janssen et al., the entire disclosure of which is incorporated herein by reference. An exemplary LCOS device that may be used in such a projection display system is described in U.S. Pat. No. 6,545,731 to Melnik et al., the entire disclosure of which is also incorporated herein by reference.

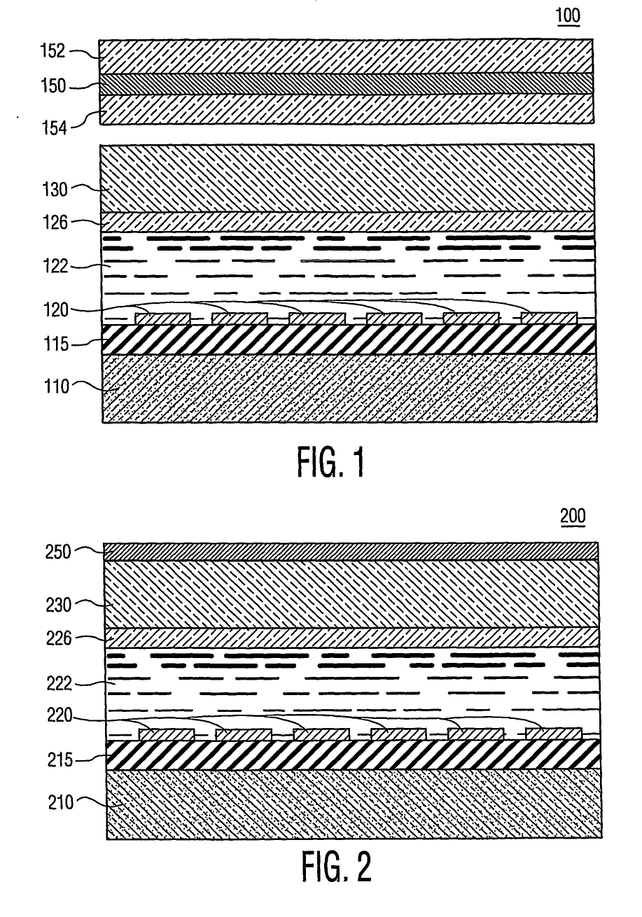

FIG. 1 illustrates a reflective LCOS device 100. The device 100 includes, in pertinent part, a silicon substrate 110 on which are provided an insulating layer 115, a plurality of reflective pixel electrodes 120, a liquid crystal layer 122, a transparent electrode 126, such as indium-tin-oxide (ITO), a transparent cover glass layer 130, and one or more separate compensator foils 150.

The reflective LCOS device 100 generally operates as follows. A high intensity, polarized light beam is directed onto at least a portion of the LCOS device 100. The polarized light beam passes through transparent cover glass layer 130, the transparent electrode 126, and liquid crystal layer 122. The polarized light beam is reflected by the reflective pixel electrodes 120, passes back through liquid crystal layer 122, and out through transparent cover glass layer 130. Where a voltage is applied across the liquid crystal material, the polarization of the light beam is altered, for example from one linear polarization to an orthogonal linear polarization. That is, the liquid crystal layer 122 acts as a polarization modulator, depending on a voltage difference applied between the pixel electrodes 120 and the transparent electrode 126. The polarization-modulated light beam emerges from the reflective LCOS device 100 and is passed through an analyzer or polarizing beamsplitter that filters out a certain polarization. The polarization-modulated light beam may then be passed though imaging lenses onto a screen to display an image.

Meanwhile, image contrast is a key parameter for any display device, including LCD devices and particularly reflective LCOS devices used in a projection display systems. Unfortunately, when driven to the dark state, the reflective LCOS device 100 still introduces a residual retardance on light impinging thereon, thereby limiting the contrast of the displayed image.

To compensate for residual retardance and thus achieve a desired contrast ratio, as shown in FIG. 1 an LCOS device 100 may be supplied with one or more separate compensator foils 150 placed on the cover glass layer 130. The compensator foil 150 is commonly a plastic type foil that is deformed (e.g., stretched) a predetermined amount in a predetermined direction to induce therein a birefringence such that light passing therethrough experiences an opposite retardance to the residual retardance provided by the reflective LCOS. Accordingly, the contrast of a displayed image is improved. The compensator foil 150 is added on top of the reflective LCOS and oriented for proper compensation of dark state residual retardance.

Indeed, although the present discussion focuses on the specific context of a reflective LCOS device, it should be understood that the problem of residual retardance, and the contrast-limiting effect thereof, applies generally to LCD devices, and compensator foils are also commonly used with direct view LCD devices. In the case of a direct view LCD device, a compensator foil also may improve the viewing angle characteristics of the display.

In practice, the compensator foil 150 is laminated between two pieces of high quality glass, 152 and 154 to maintain its shape and to provide structural support. Furthermore, each piece of glass 152 and 154 must be provided with an anti-reflection (AR) coating to minimize reflection that can further reduce the display's contrast. Moreover, this also requires that the transparent cover glass layer 130 be provided with an AR coating to minimize reflections at the interface between the transparent cover glass layer 130 and the air.

Further discussion of the problems of residual retardance and skew-angle compensation in an LCD and the use of compensation foils may be found in Jepsen U.S. Pat. No. 6,307,607, the entirety of which is hereby incorporated herein by reference for all purposes as if fully set forth herein.

Unfortunately, there are problems and disadvantages associated with such compensator foils as discussed above. As noted above, the desired retardance is induced into the compensator foil 150 by deforming (e.g., stretching) it a predetermined amount in a predetermined direction. However, the required retardance can be relatively low (e.g., 20-30 nm), and therefore a great deal of precision is required. Accordingly, it is difficult to consistently and repeatably produce compensator foils with the required amount of retardance, so the manufacturing yields are often low. Furthermore, since the compensator foil is located near the image plane of the device, its cosmetic quality must be high. Also, the high quality AR glass sheets between which the compensator foil is sandwiched add to the cost of the device. Finally, packaging and compensation foil attachment are post-semiconductor-fabrication that complicate the overall device fabrication.

Accordingly, it would be desirable to provide an improved method and device for compensating for residual phase shift in an LCD device to improve contrast It would also be desirable to a compensating device for an LCD that can be consistently and repeatedly be produced with a high yield. It would be further desirable to provide a method and device for compensating for residual phase shift in an LCD device that simplifies overall device fabrication. The present invention is directed to addressing one or more of the preceding concerns.

In one aspect of the invention, a reflective liquid crystal device comprises: a semiconductor substrate; a plurality of reflective pixel electrodes disposed above the semiconductor substrate; a liquid crystal layer disposed above the reflective pixel electrodes; at least one transparent electrode disposed above the liquid crystal layer; and a transparent cover disposed above the transparent electrode, wherein the transparent cover has formed in a surface thereof a plurality of gratings having a pitch that is less than a lowest wavelength of visible light.

In another aspect of the invention, a liquid crystal display device comprises: first and second substrates; a liquid crystal layer disposed between the first and second substrates; means for selectively changing an orientation of liquid crystal molecules of the liquid crystal layer to selectively control a polarization of light passing through the liquid crystal layer; and a form birefringent compensator on a surface of one of the two substrates through which the light exits the device.

In yet another aspect of the invention, a liquid crystal device comprises: a semiconductor substrate; a plurality of pixel electrodes disposed above the semiconductor substrate; a liquid crystal layer disposed above the pixel electrodes; at least one transparent electrode disposed above the liquid crystal layer, a transparent cover disposed above the transparent electrode; and a transparent sheet disposed above a surface of the transparent cover, the transparent sheet including a form birefringent compensator structure.

Further and other aspects will become evident from the description to follow.

FIG. 1 shows a cross-sectional representation of a liquid crystal on silicon (LCOS) device;

FIG. 2 shows a cross-sectional representation of a reflective LCOS device having a form birefringent compensator;

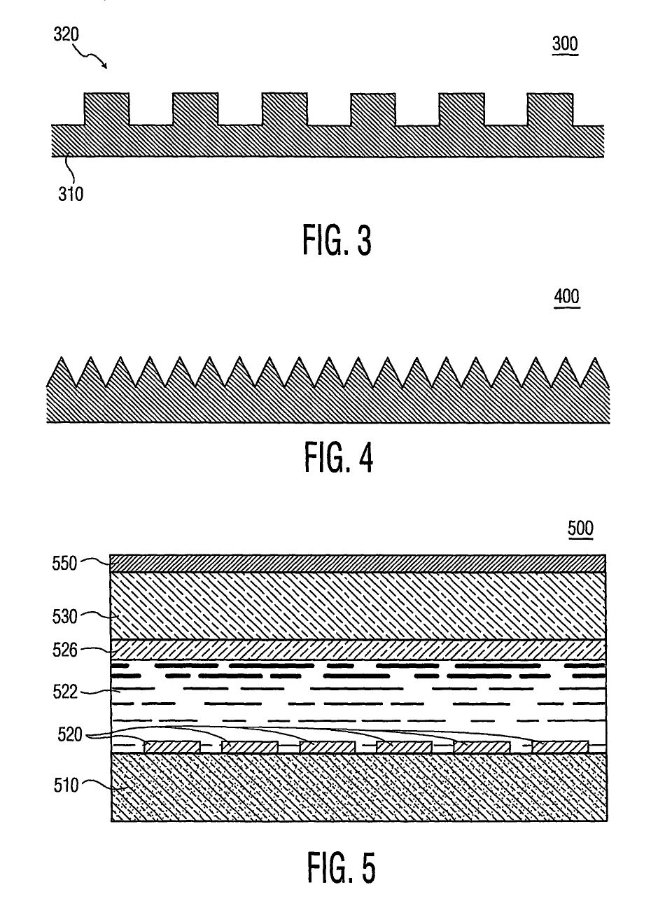

FIG. 3 shows a first embodiment of a form birefingent compensator structure for use with an LCD device;

FIG. 4 shows a first embodiment of a form birefringent compensator structure for use with an LCD device;

FIG. 5 shows a cross-sectional representation of a direct view liquid crystal display device having a form birefringent compensator.

In the description and claims to follow, when a first device or structure is said to be “on” a second device or structure, it is understood that this encompasses both the case where the first device or structure is directly on the second device or structure, and the case where there are intervening devices or structures, or even air, between the first device or structure and the second device or structure. When it is intended to state that the first device or structure is directly on the second device or structure, without any intervening devices or structures, then it will be said that the first device or structure is directly on the second device or structure.

FIG. 2 shows a cross-sectional representation of a reflective liquid crystal device 200, such as a Liquid Crystal on Silicon (LCOS) device, having a form birefringent compensator. As shown in FIG. 2, the device 200 includes, in pertinent part, a semiconductor (e.g., silicon) substrate 210 on which are provided an insulating layer 215, a plurality of reflective pixel electrodes 220, a liquid crystal layer 222, a transparent electrode 226, such as indium-tin-oxide (ITO), a transparent substrate or cover 230, and a form birefringent compensator 250.

The semiconductor substrate 210, insulating layer 215, reflective pixel electrodes 220, liquid crystal layer 222, and transparent electrode 226 are similar to corresponding elements described above with respect to FIG. 1.

However, in contrast to the device 100 shown in FIG. 1, the device 200 does not include any compensator foil 150 made of a material that is caused to have an induced birefringence by a deformation (e.g., stretching) process. Instead, the device 200 includes a form birefringent compensator 250 patterned or formed onto a surface of a transparent layer. The form birefringent compensator 250 produces a retardance in a light beam passing therethrough that compensates for a residual retardance in the liquid crystal layer 222 in a dark state, as explained in more detail below.

FIG. 3 shows a first embodiment of a form birefringent compensator structure 300 that may be used in the device 200. The form birefringent compensator structure 300 comprises a series of high frequency phase gratings formed directly on, or patterned into, a surface of a transparent material. The gratings are made of a dielectric material, such as glass. Beneficially, the period of the grating is less than the wavelength of visible light passing therethrough. In that case, the diffracted orders become evanescent, while the zero order sees an index-of-refraction profile that is related to the grating structure. For a linear grating structure, the index profile is anisotropic and thus the structure exhibits birefringence. The index of refraction of the substrate material 310 and the adjacent (incident) material 320, along with the grating period and the duty cycle, determine the effective index of refraction for light parallel and perpendicular to the grating lines.

For example, suppose that a reflective LCOS device produces a residual retardance of 30 nm that requires compensation. Also assume that the form birefringent compensator structure is formed in glass (n=1.5) at an interface with air as the incident material. With a 50% duty cycle, the refractive index difference is approximately Δn=0.1 when the period of the grating is less than about 0.3 times the wavelength of the incident light beam. In that case, the thickness of the grating would be about 300 nm.

The index difference of the form birefringent compensator structure 300 depends upon the grating period when the period approaches the wavelength of the impinging light beam. Beneficially, this property of the form birefringent compensator structure may be used to tailor the dispersion of the compensator to match the dispersion of the residual retardance of the liquid crystal device that it accompanies.

FIG. 4 shows a second embodiment of a form birefringent compensator structure 400. In the form birefringent compensator structure 400, the gratings have a triangular cross-section, as opposed to the rectangular cross-section of FIG. 3. Thus, the grating profile varies with position normal to the substrate of the form birefringent compensator structure (i.e., from a top to a bottom thereof), and the effective indices of refraction change in a monotonic fashion (no singular points) from the incident material (e.g., air) having a lower index of refraction, to the substrate material (e.g., glass) having a higher index of refraction. In other words, the cross-section of the grating has a profile where the amount of higher-index material (e.g., glass) monotonically increases from the top of the structure to the bottom thereof. Such a monotonic grating profile can provide anti-reflection properties, eliminating the need for a separate anti-reflective (A/R) layer or coating.

Other grating profiles can easily be envisioned from the above descriptions. For example, a structure with a sinusoidal cross-section can also provide a monotonically increasing grating profile and thereby eliminate the need for a separate A/R layer or coating.

Beneficially, the form birefringent compensator 250 may be relatively easily and consistently replicated in various ways. The required grating profile can be fabricated into a nickel shim that can be used to stamp the structure into a surface of a desired transparent material. Alternatively, the form birefringent compensator 250 may be patterned onto the surface of a desired transparent material by UV-curing of a polymerizing optically transparent fluid.

In an alternative embodiment, the form birefringent compensator 250 includes a grating that does not have a physical profile. The grating may be created by producing a structure having an index of refraction that is uniform along one direction, but is modulated along a second direction. For example, a form birefringent compensator 250 may be produced by exposing a monomer/liquid crystal mixture to UV light producing an interference pattern (e.g., sinusoidal) to create phase separation resulting in a refractive index/phase grating. In other words, the grating may exist as a pattern (e.g., sinusoidal) of a structural variance within the form birefringent compensator material that results in a corresponding variance in the index of refraction of the material. In that case, the physical surface of the form birefringent compensator may exhibit a flat profile.

Thus, the manufacturing yield can be improved compared to the compensator foil 150 of FIG. 1.

The form birefringent compensator 250 may be integral to a separate transparent sheet placed above the transparent cover 230, such as a transparent glass sheet that may have an A/R layer or coating thereon. As explained above, the form birefringent compensator 250 may be stamped into the transparent sheet or it may be patterned thereon, or created by another process. If the form birefringent compensator 250 is patterned onto the transparent sheet, it may comprise a different material structure than the transparent sheet, which then acts as a carrier for the form birefringent compensator 250.

Beneficially, the form birefringent compensator 250 may be integral to the transparent cover 230 of FIG. 2, formed into, or directly on, a surface thereof. In that case, the anti-reflection properties of the grating can eliminate the need for any A/R coating thereon. This may greatly simplify the overall device fabrication process as compared with the device discussed above with respect to FIG. 1. Beneficially, the transparent cover 230 and the form birefringent compensator 250 each comprise glass, but other suitable transparent materials may be substituted. As explained above, the form birefringent compensator 250 may be stamped into the transparent cover 230 or it may be patterned thereon, or created by another process. If the form birefringent compensator 250 is patterned onto the transparent cover 230, it may comprises a different material structure than the transparent cover 230,

Although the principles have been illustrated above in the context of a reflective LCOS device, the form birefringent compensator may be more widely applied to liquid crystal display (LCD) devices. FIG. 5 shows a direct view LCD panel 500. The LCD panel 500 includes, in pertinent part: first and second substrates 510 and 530; a liquid crystal layer 522 disposed between the first and second substrates 510 and 530; first and second electrodes 520 and 526 disposed respectively on the first and second substrates 510 and 530; and a form birefringent compensator 550 on a surface of the second substrate 530 through which the light exits the device. Other conventional features such as dielectric layers, black matrix layers, thin film transistor (FIT) pixel switches, and color filters are typically included in such a direct view LCD device but are not shown in FIG. 5 for ease of explanation. Furthermore, although the device 500 is shown having pixel electrodes 520 on the first substrate 510 and second electrodes 526 on the second substrate 530, the first and second electrodes could assume any known structure, such as a lateral structure with side-by-side electrodes on a same substrate, etc. The important thing is that the device 500 includes some means for selectively changing an orientation of liquid crystal molecules of the liquid crystal layer 522 to selectively control a polarization of light passing through the liquid crystal layer 522.

Similarly to the device 200, in the direct view LCD panel 500, the form birefingent compensator 550 may be integral to the second substrate 530, or may be integral to a separate transparent sheet placed above the top surface of the second substrate 530.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A reflective liquid crystal on silicon (LCOS) device (200), comprising:
a semiconductor substrate (210);
a plurality of reflective pixel electrodes (220) disposed above the semiconductor substrate;
a liquid crystal layer (222) disposed above the reflective pixel electrodes (220);
at least one transparent electrode (260) disposed above the liquid crystal layer (222); and
a transparent cover (230) disposed above the transparent electrode (260), wherein the transparent cover (260) is provided in a surface thereof with a form birefringent compensator structure (250) comprising a plurality of gratings having a pitch that is less than a lowest wavelength of visible light.

2. The device (200) of claim 1, wherein the form birefringent compensator structure (250) is adapted to provide a first average index of refraction to light having a first polarization and to provide a second average index of refraction to light having a second polarization, where the first and second average indices of refraction are not equal.

3. The device (200) of claim 1, wherein the form birefringent compensator structure (250) compensates for a residual retardance produced by the liquid crystal layer (222) when the device (200) is operating in a dark state.

4. The device (200) of claim 1, wherein the plurality of gratings each have a triangular cross-section.

5. The device (200) of claim 1, wherein each grating has a cross-section wherein an amount of material in the structure increases monotonically from a top of the grating to a bottom thereof.

6. The device (200) of claim 1, wherein the form birefringent compensator structure (250) comprises a UV-cured polymerizing substance patterned directly on a top surface of the transparent cover (230).

7. A liquid crystal display device (500), comprising:
first and second substrates (510, 530);
a liquid crystal layer (522) disposed between the first and second substrates (510, 530);
means (520, 526) for selectively changing an orientation of liquid crystal molecules of the liquid crystal layer (522) to selectively control a polarization of light passing through the liquid crystal layer (522); and
a form birefringent compensator (550) on a surface of one of the two substrates (510, 530) through which the light passes.

8. The device (500) of claim 7, wherein the form birefringent compensator (550) is integral to the one substrate (510, 530).

9. The device (500) of claim 7, wherein the form birefringent compensator (550) is integral to a separate transparent sheet disposed above the one substrate (510, 530).

10. The device (500) of claim 9, wherein the form birefringent compensator (550) is formed into the transparent sheet of a same material as the transparent sheet.

11. The device (500) of claim 7, wherein the form birefringent compensator (550) comprises a material having an index of refraction that is modulated in one direction.

12. The device (500) of claim 7, wherein the form birefringent compensator (400) comprises a plurality of gratings having a rectangular cross-section.

13. The device (500) of claim 7, wherein the form birefringent compensator (550) comprises a plurality of gratings wherein each grating has a cross-section wherein an amount of material in the structure increases monotonically from a top of the grating to a bottom thereof.

14. The device (500) of claim 7 wherein the means (520, 526) for selectively changing an orientation of liquid crystal molecules of the liquid crystal layer (522) to selectively control a polarization of light passing through the liquid crystal layer includes a first electrode (520) on the one (510) of the two substrates and a second electrode (526) on the other (530) of the two substrates.

15. A liquid crystal device (200), comprising:
a semiconductor substrate (210);
a plurality of pixel electrodes (220) disposed above the semiconductor substrate (210);
a liquid crystal layer (222) disposed above the pixel electrodes (220);
at least one transparent electrode (260) disposed above the liquid crystal layer (222);
a transparent cover (230) disposed above the transparent electrode (260); and
a transparent sheet (250) provided above a surface of the transparent cover (250), the transparent sheet including a form birefringent compensator structure.

16. The device (200) of claim 15, wherein the form birefringent compensator structure is formed into the transparent sheet (250) of a same material as the transparent sheet (250).

17. The device (200) of claim 15, wherein the form birefringent compensator structure comprises a UV-cured polymerizing substance patterned directly on a top surface of the transparent sheet (250).

18. The device (200) of claim 15, wherein the form birefringent compensator structure comprises a plurality of gratings wherein each grating has a cross-section wherein an amount of material in the structure increases monotonically from a top of the grating to a bottom thereof.

19. The device (200) of claim 15, wherein the form birefringent compensator structure (400) comprises a plurality of gratings having a triangular cross-section.

20. The device (200) of claim 15, wherein the form birefringent compensator structure comprises a material having an index of refraction that is modulated in one direction.
